(19) United States
(12) Patent Application Publication
(10) Pub. No.: US 2014/0236884 A1
(43) Pub. Date: Aug. 21, 2014

(54) ANALYSIS OF DATASETS WITHOUT PREDEFINED DIMENSIONS

(71) Applicants: Mitchell Clark, Alexandria, VA (US); Celso da Silveira, Herndon, VA (US); Julian Ogando, Buenos Aires (AR)

(72) Inventors: Mitchell Clark, Alexandria, VA (US); Celso da Silveira, Herndon, VA (US); Julian Ogando, Buenos Aires (AR)

(73) Assignee: SAP AG, Walldorf (DE)

(21) Appl. No.: 13/768,952

(22) Filed: Feb. 15, 2013

(51) Int. Cl. G06F 17/30

(52) U.S. Cl. CPC G06F 17/30592
USPC 707/602

(57) ABSTRACT

Embodiments of systems, methods, and computer-readable mediums for analysis of datasets without predefined dimensions are generally described herein. In some embodiments, analysis of datasets without predefined dimensions may include receiving a selection of multiple dimensions of information from a database to be used for data analysis; receiving a selection for a type of report; and dynamically generating a query statement based on the selection of the multiple dimensions. Further embodiments may include the dynamically generated query statement including multiple iterative join clauses as a function of the selected dimensions; executing the query statement against an in-memory database; and displaying columns of information obtained from execution of the query statement.

### BACKGROUND INFORMATION

Traditional Business Intelligence (a.k.a., “BI”) tools provide capabilities to analyze data sets where the dimensions (a.k.a., “characteristics”) are static and can be defined during the data modeling and report creation process (as opposed to query run time). For example, a semantic layer object (e.g., Universe in business object (BOBJ) parlance) and/or a BI data store object (e.g., a table in a Relational Database Management System (RDMS) or a “cube” in an online analytical processing system) can be created that contains predefined dimensions, such as material, customer, country, etc. The Universe can then be used as the basis for a report that provides the ability to analyze a data set along the predefined dimensions. However, traditional BI tools and modeling techniques do not adequately handle analysis of data sets where the dimensions are very dynamic and flexible and can only be defined at run time of the report/query.

In addition, traditional BI tools provide capabilities to analyze data sets where the dimensions are stored as separate individual columns in a RDMS table or multi-dimension cube. However, these tools do not provide the capability to analyze a dataset where the dimensions are stored as separate rows in an online transaction processing (OLTP) table, where the only linkage between the dimensions is via a common key stored with each row.

### BRIEF DESCRIPTION OF THE DRAWINGS

FIG. 1 illustrates an architecture of a system supporting analysis of datasets without predefined dimensions, in accordance with some embodiments;

FIG. 2 illustrates a graphical user interface for analyzing datasets without predefined dimensions, in accordance with some embodiments;

FIG. 3 illustrates another aspect of a graphical user interface for analyzing datasets without predefined dimensions, in accordance with some embodiments;

FIG. 4 illustrates another aspect of a graphical user interface for analyzing datasets without predefined dimensions, in accordance with some embodiments;

FIG. 5 illustrates another aspect of a graphical user interface for analyzing datasets without predefined dimensions, in accordance with some embodiments;

FIG. 6 illustrates a result report generated from analyzing datasets without predefined dimensions, in accordance with some embodiments;

FIG. 7 illustrates a method of analyzing datasets without predefined dimensions, in accordance with some embodiments; and

FIG. 8 illustrates a functional block diagram of an example machine for analyzing datasets without predefined dimensions, in accordance with some embodiments.

### DETAILED DESCRIPTION

Current data modeling techniques have several significant limitations. For example, to be able to analyze data quickly, a data store object (e.g., an RDMS table) or online analytical processing (OLAP) cube must be created for the superset of all possible dimensions that may be analyzed, or multiple data store objects must be created for the dimensions that will likely be used during the analysis. Either of these approaches involves replicating data, which requires additional memory for storage.

Another limitation of current data modeling techniques is that a static data store object (along with any downstream data store objects, queries, and reports) must be adjusted and maintained when a new dimension is added or removed from the analysis. This increases the maintenance effort and cost associated with the analysis.

Another limitation of current data modeling techniques is that creating additional data store objects precludes the ability to do real-time analysis against the transactional OLTP tables/data because a static query or pre-defined cube must be updated to reflect a new data store object before analysis of that data store object is possible.

With existing database modeling techniques, the data store object or multidimensional cube in an OLAP system would contain all the predefined dimensions that may be required in the query analysis. The dimensions would be data fields in a data structure. For example, if a database contained information about products, a “Pump” data store object may have dimensions such as “Model,” “Type,” “Rotation Direction,” “Housing Color,” etc. A “Car” data store object may have dimensions “Engine,” “Exterior Color,” “Model,” “Year,” “Seat Type,” etc. The dimensions are predefined in the structure of the data store object (e.g., the dimensions are data fields in the data store object), and therefore, static. If a new dimension needs to be added to or removed from a data store object, the structure of the data store object must be changed, along with any other database item (e.g., data store object, query, etc.) that depends on the modified data store object. In addition, if analysis is required on another data store object with different dimensions, a separate data store object must be created. Once the new data store object has been created, the data contained in the new data store object must be extracted, transformed, and loaded into a data warehouse before it can be analyzed.

In some embodiments, the data to be analyzed may be stored in native OLTP tables. Rather than storing the dimensions of a data store object as columns of a table associated with that data store object, the dimensions of a data store object may be stored as separate rows in an OLTP table. The link between different dimensions of the same data store object may be via a common key stored with or within each row. The dimensions for all data store objects may be stored in one OLTP table, and the dimension values for those dimensions may be stored in another OLTP table. To associate a dimension with a value for that dimension, the dimension table and the dimension value table may be joined in an SQL query.

In some embodiments, a graphical user interface may be presented to a user. The user may use the GUI to determine the available dimensions that can be used for data analysis, as well as to select specific dimensions to include in analysis reports.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to limit voluntarily the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

In some embodiments, a database that performs analysis of datasets without predefined dimensions may be an in-memory database. An in-memory database is a database that resides entirely in random-access memory of one or more computers, rather than the traditional paradigm of having some modules of the database platform reside in random-access memory and other modules of the database platform reside on secondary storage, such as a hard drive.

In some embodiments, an application server may be used to generate the user interface components displayed to the user. The application server may be integrated with or embedded within the database, or may be a separate component from the database.

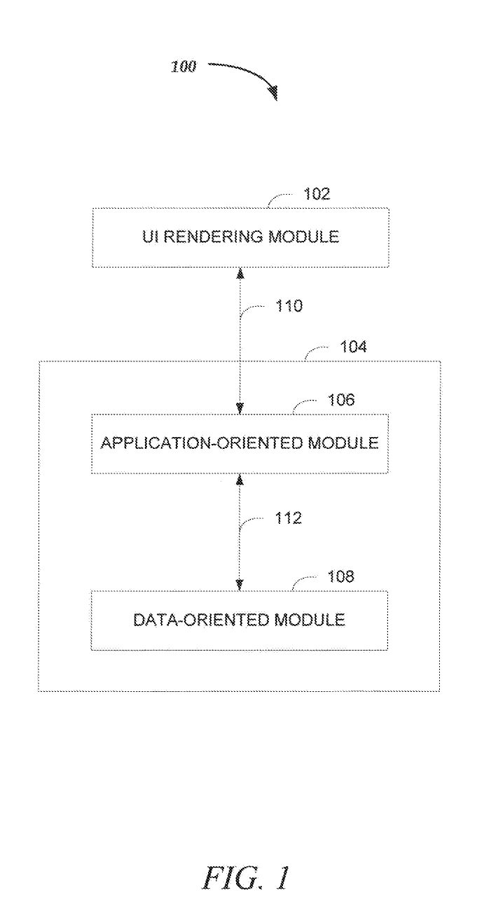

Referring now to the figures, FIG. 1 illustrates an architecture of a system 100 supporting analysis of datasets without predefined dimensions, in accordance with some embodiments. The database 104 may contain an application-oriented module 106 and a data-oriented module 108. The application-oriented module 106 may contain application logic specific to one or more applications. The data-oriented module 108 may contain data-oriented application logic, as well as SQL queries, views, stored procedures, etc. The UI rendering module 102 may generate data for rendering a user interface (UI) to a user of the system 100.

In some embodiments, the UI rendering module 102 is a web browser, such as Internet Explorer®, Firefox®, Chrome™, Safari®, Opera™, etc. In some embodiments, the database 104 is an in-memory database, such as SAP HANA. In some embodiments, where the database 104 is an SAP HANA database, the application-oriented module 106 may be SAP HANA Extended Application Services (a.k.a., “XS” or “XS Engine.”)

The database 104 and the UI rendering module 102 may communicate 110 with each other via a publicly available protocol or via a proprietary protocol. Examples of publicly available protocols are Hypertext Transfer Protocol (HTTP), Hypertext Transfer Protocol Secure (HTTPS), Transmission Control Protocol (TCP), and Transmission Control Protocol over Internet Protocol (TCP/IP), or any other suitable communications protocol.

In embodiments where the database 104 is an in-memory database, the application-oriented module 106 and the data-oriented module 108 may communicate 112 with each other via one or more methods of inter-process communication, such as files, signals, sockets, message queues, pipes, named pipes, semaphores, shared memory, message passing, memory-mapped files, etc.

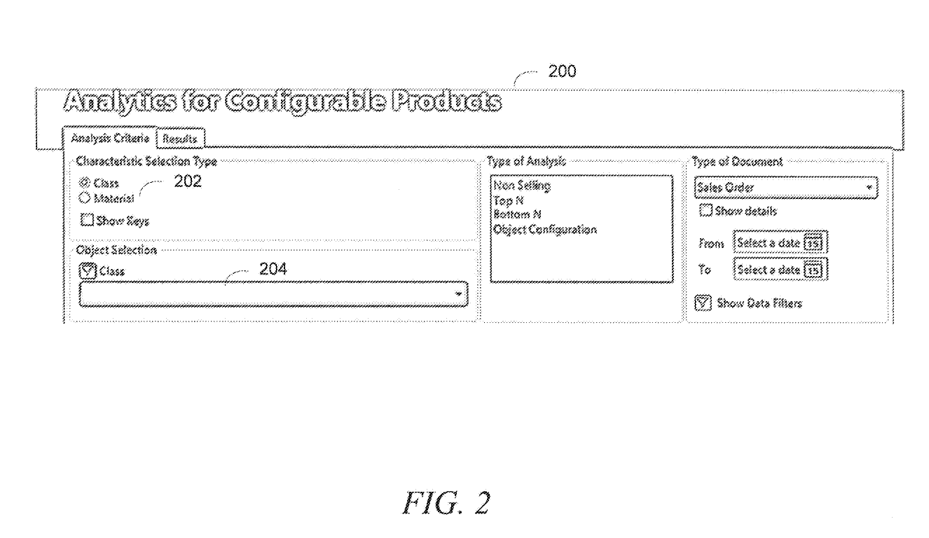

FIG. 2 illustrates a graphical user interface 200 for analyzing datasets without predefined dimensions, in accordance with some embodiments. The user may begin the data analysis by selecting a characteristic selection type 202. Based on the characteristic selection type 202 selected by the user, the database dynamically generates a SQL query. The purpose of this query is to retrieve data for populating an object selection list 204. In an example embodiment, if a user selects the “Class” characteristic selection type 202, the database dynamically generates the following SQL query:

SELECT DISTINCT CLASS, KSCHL FROM
“_SYS_BIC”.“i010195/QCLASS_CHAR_VALUE”

The resulting data returned by the database executing this SQL query may be the following list of classes available in the database, set forth in TABLE 1:

TABLE 1
Result Set of “CLASS” SQL Query

| CLASS | KSCHL |
|---|---|
| EHS_0101_001 | Material Safety Data Sheet Shipping |
| EHS_1022_024 | Dangerous Goods Regulations |
| EHS_1022_029 | Additional Data for Transport |
| EHS_1023_024 | Poisonous by Inhalation (US) |
| EHS_1022_035 | More Information About Classes . . . |
| EHS_1022_040 | Activity Limits (Class 7) |
| EHS_1022_041 | Limits of Radioactivity |
| EHS_1022_044 | Activity Limits of Radionuclide |
| EHS_1025_001 | Full UN Packaging Code |
| EHS_1025_003 | Packaging Groups |
| EHS_1025_005 | Single/Outer Packaging |
| EHS_1023_057 | Registration (Company-Specific) |
| EHS_1024_057 | REACH |
| EHS_1025_057 | Substance Volume Tracking |

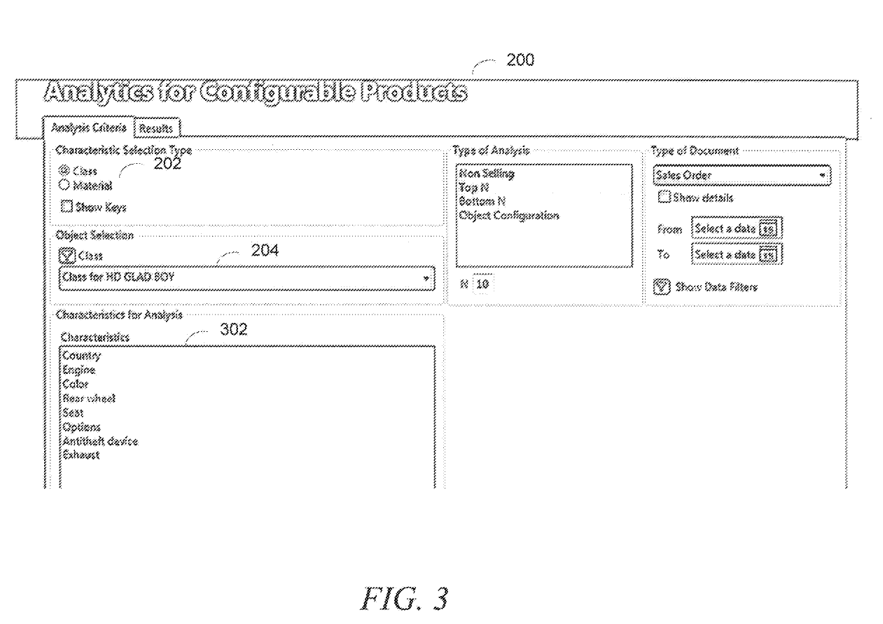

FIG. 3 illustrates another aspect of a graphical user interface 200 for analyzing datasets without predefined dimensions, in accordance with some embodiments. After receiving the data resulting from the “CLASS” SQL query, the GUI 200 may then populate an object selection list 204 with the names of the classes returned in the result set. The user may then continue the data analysis by selecting a class listed in the list of class names in object selection list 204. Based on the class selected by the user, the database dynamically generates a SQL query. The purpose of this query is to populate a selection list 302 of the available characteristics for the selected class. In the example embodiment, if a user selects “Class for HD GLAD BOY,” which has an ID of “HD-000” as the class in object selection list 204, the database dynamically generates the following SQL query:

SELECT DISTINCT ATINN, ATBEZ FROM
“_SYS_BIC”.“i010195/QCLASS_CHAR_VALUE” WHERE CLASS =
‘HD-000’

The resulting data returned by the database executing this SQL query may be the following list of characteristics in the database for “Class for HD GLAD BOY,” set forth in TABLE 2:

TABLE 2
Result Set of “Class for HD GLAD BOY” Query

| ATINN | ATBEZ |
|---|---|
| 0000000113 | Country |
| 0000000114 | Engine |
| 0000000115 | Color |
| 0000000116 | Rear wheel |
| 0000000117 | Seat |
| 0000000118 | Options |
| 0000000124 | Antitheft device |
| 0000000991 | Exhaust |

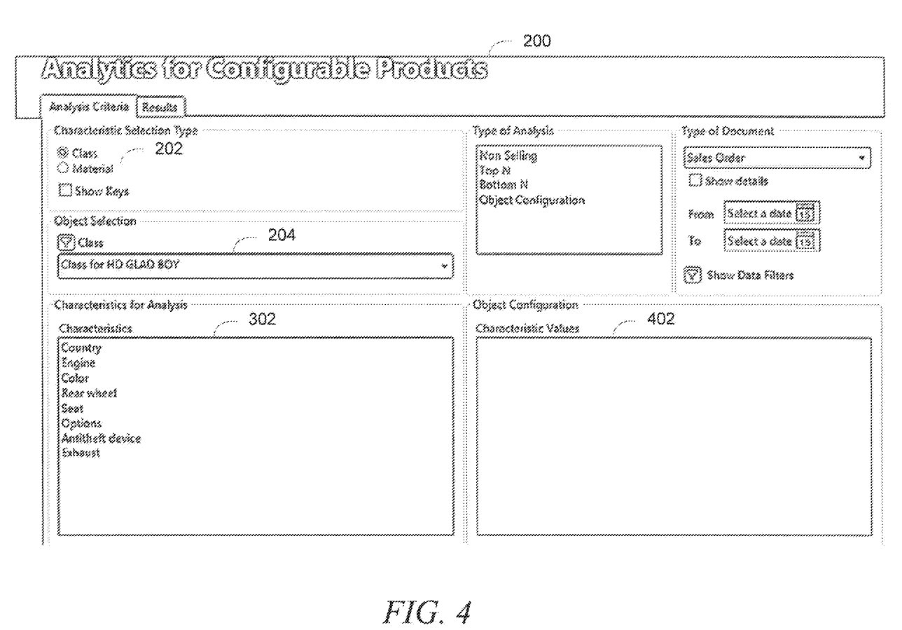

FIG. 4 illustrates another aspect of a graphical user interface 200 for analyzing datasets without predefined dimensions, in accordance with some embodiments. After receiving the data resulting from the “Class for HD GLAD BOY” query, the GUI 200 may populate the list of characteristics for analysis 302 with the names of the characteristics available for the class selected in object selection list 204. The user may then continue the data analysis by selecting one or more characteristics listed in the list of characteristics for analysis 302. Based on the characteristic(s) selected by the user, the database dynamically generates a SQL query. The purpose of this query is to populate a selection list of the available characteristic values 402 for the selected characteristic(s). In the example embodiment, if a user selects the characteristics “Country” and “Color,” which have keys “0000000113” and “0000000115” respectively, the database dynamically generates the following SQL query:

SELECT DISTINCT “ATBEZ”, “ATINN”, “ATZHL”, “ATWTB”
FROM “_SYS_BIC”.“i010195/QCLASS_CHAR_VALUE_SOLD_UNSOLD”
WHERE “ATINN” IN (‘0000000113’,‘0000000115’)

The resulting data returned by the database executing this SQL query may be the following list of characteristic values in the database for characteristics “Country” and “Color” of “Class for HD GLAD BOY,” set forth in TABLE 3:

TABLE 3
Result Set of “Country & Color for Class for HD GLAD BOY”
Query

| ATBEZ | ATINN | ATZHL | ATWTB |
|---|---|---|---|
| Country | 0000000113 | 0003 | 49 States |
| Color | 0000000115 | 0002 | Black |
| Country | 0000000113 | 0002 | California |
| Country | 0000000113 | 0001 | International |
| Color | 0000000115 | 0003 | Red |
| Color | 0000000115 | 0001 | Silver |

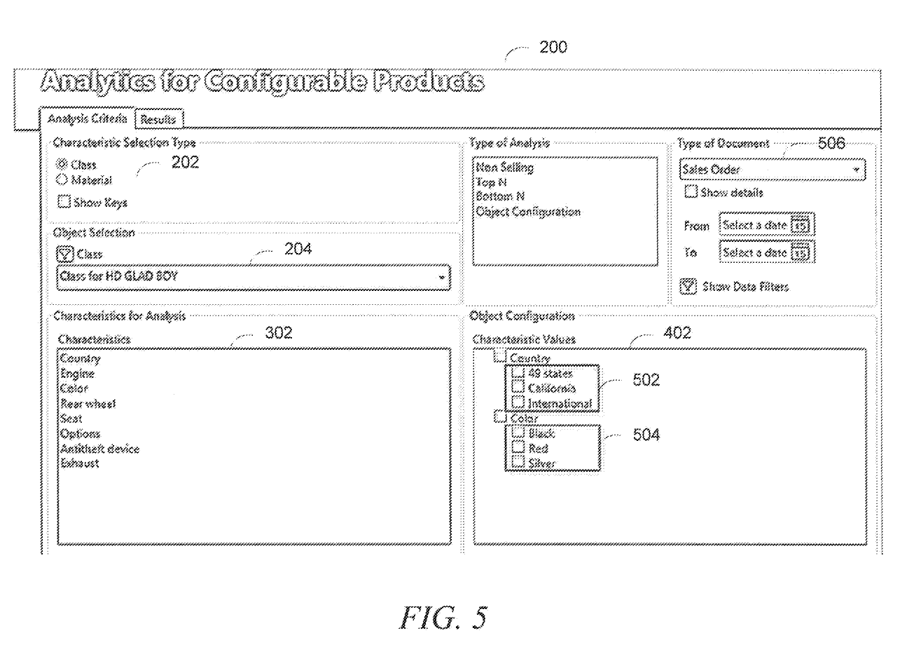

FIG. 5 illustrates another aspect of a graphical user interface 200 for analyzing datasets without predefined dimensions, in accordance with some embodiments. After receiving the data resulting from the “Country & Color for Class for HD GLAD BOY” query, the GUI 200 may then populate a characteristic values selection list 402 with the names of the characteristic values available for the selected characteristic(s) in the list of characteristics for analysis 302. The user may then continue the data analysis by selecting one or more characteristic values 502, 504 listed in the list of characteristic values 402 available for the selected characteristic(s), as well as selecting the type of document 506 to retrieve. Based on the characteristic value(s) 502, 504 selected by the user and the type of document selected by the user, a SQL query is dynamically created. The purpose of this query is to perform the analysis specified in the document type selected on the characteristic value(s) 502, 504 selected. In the example embodiment, if a user selects the characteristic value “California” for characteristic “Country,” characteristic values “Black” and “Red” for characteristic “Color,” and “Sales Order” as the type of document, the database dynamically generates the following SQL query:

SELECT A.ATWTB AS “Country”, B.ATWTB AS “Color”,
SUM(A.KWMENG) AS “Quantity”
FROM “_SYS_BIC”.“i010195/CA_MATNR_CHARVAL_SOLD”
AS A,
“_SYS_BIC”.“i010195/CA_MATNR_CHARVAL_SOLD” AS B
WHERE A.VBELN =B.VBELN
AND A.ATINN =‘0000000113’ AND A.ATZHL IN(0002)
AND B.ATINN =‘0000000115’ AND B.ATZHL IN(0002,0003)
GROUP BY A.ATWTB, B.ATWTB

The SQL query generated may include multiple iterative join and/or selection clauses against the same table or view, depending upon the number of characteristics selected by the user in the previous selection steps. Each characteristic selected for analysis may be included in at least one join iteration for that characteristic. For example, if a user selects eight different characteristics in the previous steps, then eight join iterations may be generated in the SQL query. In the example embodiment, the user selected two characteristics (“Country” and “Color”) for analysis; thus, one selection via the view (“_SYS_BIC”.“i010195/CA_MATNR_CHARVAL_SOLD”) with characteristic “Country” and another selection against the same view with characteristic “Color” were generated.

The resulting data returned by the database executing this SQL query may be the following data, set forth in TABLE 4:

TABLE 4
Result Set of Sales Order query

| Country | Color | Quantity |
|---|---|---|
| California | Black | 20 |
| California | Red | 20 |

This result shows that 20 Black HD Glad Boy motorcycles were sold in California, and 20 Red HD Glad Boy motorcycles were sold in California. The characteristics/columns (both the number of resulting characteristics/columns and the characteristic name itself) included in this output are dependent upon the characteristics selected by the user in the previous steps.

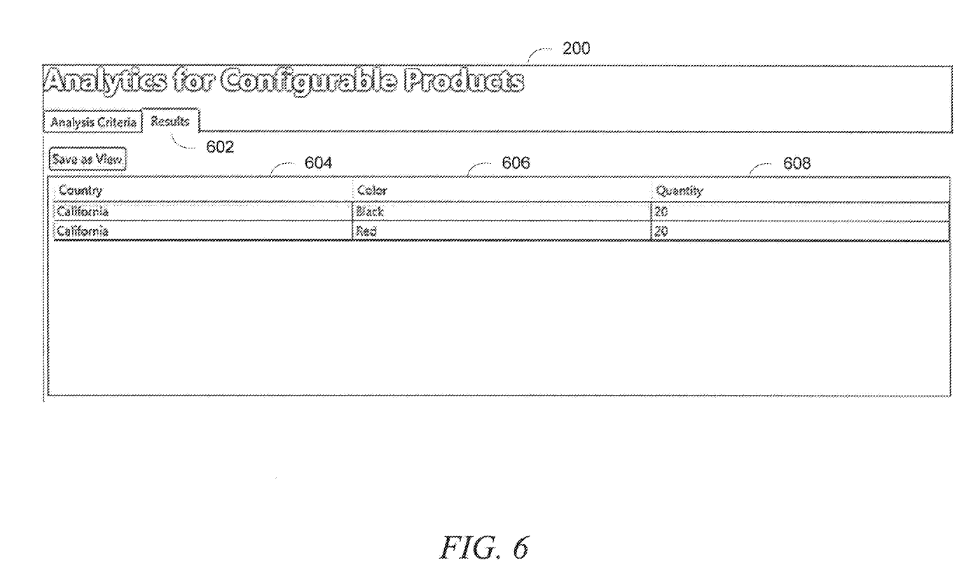

FIG. 6 illustrates a result report generated from analyzing datasets without predefined dimensions, in accordance with some embodiments. After receiving the data resulting from the “Sales Order” query, the GUI 200 may then populate a results report 602, which may display as a grid the data returned from execution of the “Sales Order” query. Each selected characteristic may be displayed in its own column. In the example embodiment, the user selected the characteristics “Country” and “Color” for analysis; thus, the grid contains a Country column 604 and a Color column 606. The grid also contains a Quantity column 608, which was included in the dynamically generated SQL query because of the selected document type 506.

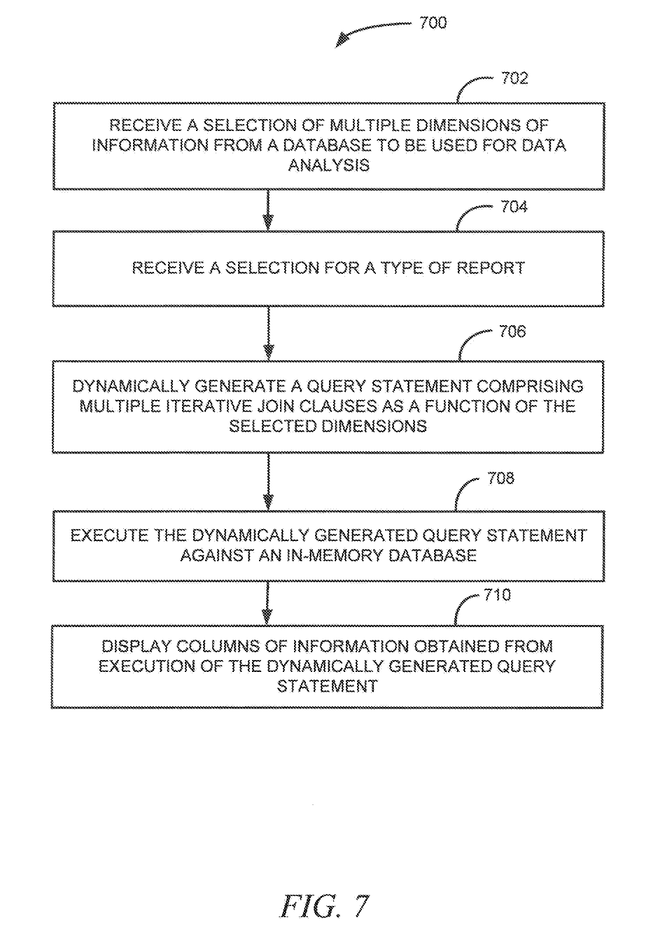

FIG. 7 illustrates a method 700 of analyzing datasets without predefined dimensions, in accordance with some embodiments. In some embodiments, a selection of multiple dimensions of information from a database to be used for data analysis is received 702. In some embodiments, a selection for a type of report is then received 704. In some embodiments, a query statement comprising multiple iterative join clauses as a function of the selected dimensions is then dynamically generated 706. In some embodiments, the dynamically generated query statement is then executed against an in-memory database 708. In some embodiments, the columns of information obtained from execution of the dynamically generated query statement are then displayed 710.

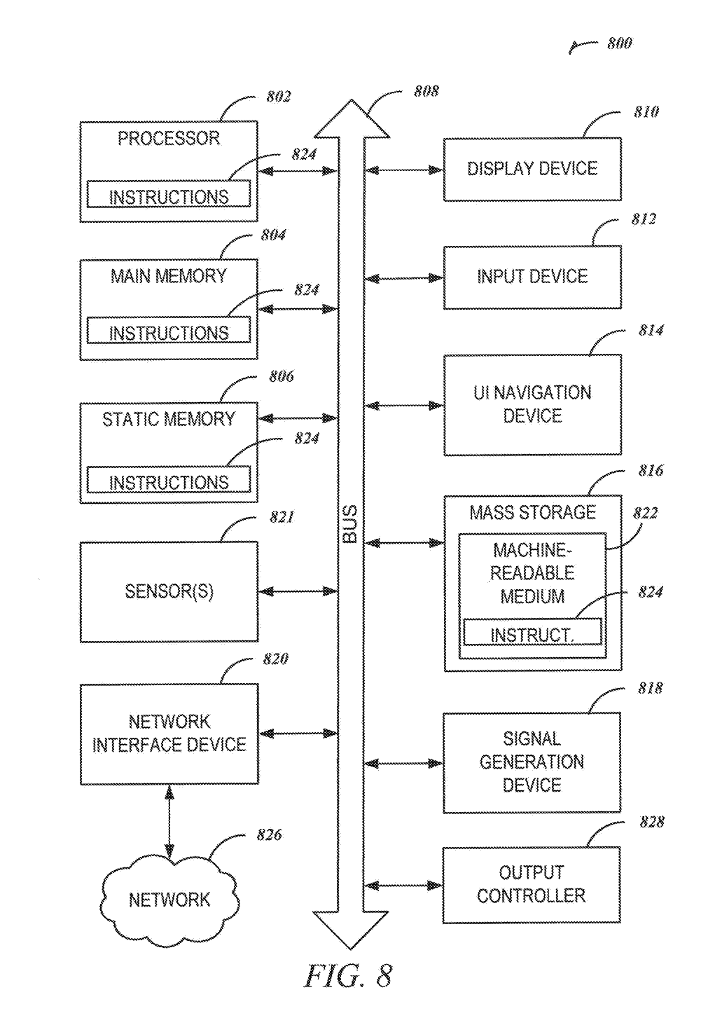

FIG. 8 illustrates a functional block diagram of an example machine 800, in accordance with some embodiments, upon which any one or more of the techniques (e.g., methodologies) discussed herein can perform. In alternative embodiments, the machine 800 can operate as a standalone device or can be connected (e.g., networked) to other machines. In a networked deployment, the machine 800 can operate in the capacity of a server machine, a client machine, or both in server-client network environments. In an example, the machine 800 can act as a peer machine in peer-to-peer (P2P) (or other distributed) network environment. The machine 800 can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor can be configured as respective different modules at different times. Software can accordingly configure a hardware processor, for example, to constitute a particular module at one instance of time and to constitute a different module at a different instance of time.

Machine (e.g., computer system) 800 can include a hardware processor 802 (e.g., a central processing unit (CPU), a graphics processing unit (GPU), a hardware processor core, or any combination thereof), a main memory 804 and a static memory 806, some or all of which can communicate with each other via a bus 808. The machine 800 can further include a display unit 810, an alphanumeric input device 812 (e.g., a keyboard), and a user interface (UI) navigation device 814 (e.g., a mouse). In an example, the display unit 810, input device 812 and UI navigation device 814 can be a touch screen display. The machine 800 can additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 can include an output controller 828, such as a serial (e.g., universal serial bus (USB), parallel, or other wired or wireless (e.g., infrared (IR)) connection to communicate or control one or more peripheral devices (e.g., a printer, card reader, etc.).

The storage device 816 can include a machine-readable medium 822 on which is stored one or more sets of data structures or instructions 824 (e.g., software) embodying or utilized by any one or more of the techniques or functions described herein. The instructions 824 can also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 can constitute machine-readable media.

While the machine-readable medium 822 is illustrated as a single medium, the term “machine-readable medium” can include a single medium or multiple media (e.g., a centralized or distributed database, and/or associated caches and servers) that configured to store the one or more instructions 824.

The term “machine-readable medium” can include any tangible medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples can include solid-state memories, and optical and magnetic media. Specific examples of machine-readable media can include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 can further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 820 can include one or more physical jacks (e.g., Ethernet, coaxial, or phone jacks) or one or more antennas to connect to the communications network 826. In an example, the network interface device 820 can include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

Although example machine 800 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of system 800 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, system 800 may include one or more processors and may be configured with instructions stored on a computer-readable storage device.

### Additional Notes and Examples

Example 1 may include subject matter (such as an apparatus, a system, a method, a means for performing acts, or a machine readable medium including instructions that, when performed by a machine cause the machine to performs acts) comprising receiving a selection of multiple dimensions of information from a database to be used for data analysis; receiving a selection for a type of report; and dynamically generating a query statement based on the selection of the multiple dimensions.

In Example 2, the subject matter of Example 1 may optionally include executing the query statement against an in-memory database; and displaying columns of information obtained from execution of the query statement.

In Example 3, the subject matter of either Example 1 or Example 2, may optionally include the columns of information displayed selected as a function of the type of report selected.

In Example 4, the subject matter of one or any of Examples 1-3 may optionally include the columns of information displayed selected as a function of the dimensions selected.

In Example 5, the subject matter of one or any of Examples 1-4 may optionally include the columns of information displayed selected as a function of the type of report selected and the dimensions selected.

In Example 6, the subject matter of one or any of Examples 1-5 may optionally include the dimensions selected from a list of characteristics.

In Example 7, the subject matter of one or any of Examples 1-6 may optionally include the dynamically generated query statement comprising multiple iterative join clauses as a function of the selected dimensions.

Example 8 may include, or may optionally be combined with the subject matter of one or any of Examples 1-7 to include, subject matter (such as an apparatus, a system, a method, a means for performing acts, or a machine readable medium including instructions that, when performed by a machine cause the machine to performs acts) comprising at least one processor programmed to receive a selection of multiple dimensions of information from a database to be used for data analysis; wherein the at least one processor is further programmed to receive a selection for a type of report; and wherein the at least one processor is further programmed to generate dynamically a query statement based on the selection of the multiple dimensions.

In Example 9, the subject matter of one or any of Examples 1-8 may optionally include the at least one processor programmed to execute the query statement against an in-memory database; wherein the at least one processor is further programmed to execute the query statement to obtain columns of information; and wherein the at least one processor causes the columns of information to be displayed.

In Example 10, the subject matter of one or any of Examples 1-9 may optionally include the columns of information displayed selected by the at least one processor as a function of the type of report.

In Example 11, the subject matter of one or any of Examples 1-10 may optionally include the columns of information displayed selected by the at least one processor as a function of the dimensions selected.

In Example 12, the subject matter of one or any of Examples 1-11 may optionally include the columns of information displayed selected by the at least one processor as a function of the type of report selected and the dimensions selected.

In Example 13, the subject matter of one or any of Examples 1-12 may optionally include the dynamically generated query statement comprising multiple iterative join clauses as a function of the selected dimensions.

In Example 14, the subject matter of one or any of Examples 1-13 may optionally include the type of report selected from a list of reports.

Example 15 may include, or may optionally be combined with the subject matter of one or any of Examples 1-14 to include, subject matter (such as an apparatus, a system, a method, a means for performing acts, or a machine readable medium including instructions that, when performed by a machine cause the machine to performs acts) comprising a plurality of instructions that, in response to being executed on a computing device, cause the computing device to receive a selection of multiple dimensions of information from a database to be used for data analysis; receive a selection for a type of report; and dynamically generate a query statement based on the selection of the multiple dimensions.

In Example 16, the subject matter of one or any of Examples 1-15 may optionally include the plurality of instructions, when executed on the computing device, causes the computing device to execute the query statement against an in-memory database and to display columns of information obtained from execution of the query statement.

In Example 17, the subject matter of one or any of Examples 1-16 may optionally include the columns of information displayed selected as a function of the type of report selected.

In Example 18, the subject matter of one or any of Examples 1-17 may optionally include the columns of information displayed selected as a function of the dimensions selected.

In Example 19, the subject matter of one or any of Examples 1-18 may optionally include the columns of information displayed selected as a function of the type of report selected and the dimensions selected.

In Example 20, the subject matter of one or any of Examples 1-19 may optionally include the dynamically generated query statement comprising multiple iterative join clauses as a function of the selected dimensions.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising:
receiving a selection of multiple dimensions of information from a database to be used for data analysis;
receiving a selection for a type of report; and
dynamically generating a query statement based on the selection of the multiple dimensions.

2. The method of claim 1, further comprising:
executing the query statement against an in-memory database; and
displaying columns of information obtained from execution of the query statement.

3. The method of claim 2, wherein the columns of information displayed are selected as a function of the type of report selected.

4. The method of claim 2, wherein the columns of information displayed are selected as a function of the dimensions selected.

5. The method of claim 2, wherein the columns of information displayed are selected as a function of the type of report selected and the dimensions selected.

6. The method of claim 1, wherein the dimensions are selected from a list of characteristics.

7. The method of claim 1, wherein the dynamically generated query statement comprises multiple iterative join clauses as a function of the selected dimensions.

8. A system, comprising:
at least one processor programmed to receive a selection of multiple dimensions of information from a database to be used for data analysis;
wherein the at least one processor is further programmed to receive a selection for a type of report; and
wherein the at least one processor is further programmed to generate dynamically a query statement based on the selection of the multiple dimensions.

9. The system of claim 8, further comprising:
the at least one processor programmed to execute the query statement against an in-memory database;
wherein the at least one processor is further programmed to execute the query statement to obtain columns of information; and
wherein the at least one processor causes the columns of information to be displayed.

10. The system of claim 9, wherein the columns of information displayed are selected by the at least one processor as a function of the type of report.

11. The system of claim 9, wherein the columns of information displayed are selected by the at least one processor as a function of the dimensions selected.

12. The system of claim 9, wherein the columns of information displayed are selected by the at least one processor as a function of the type of report selected and the dimensions selected.

13. The system of claim 8, wherein the dynamically generated query statement comprises multiple iterative join clauses as a function of the selected dimensions.

14. The system of claim 8, wherein the type of report is selected from a list of reports.

15. A computer-readable medium comprising a plurality of instructions that, in response to being executed on a computing device, cause the computing device to:
receive a selection of multiple dimensions of information from a database to be used for data analysis;
receive a selection for a type of report; and
dynamically generate a query statement based on the selection of the multiple dimensions.

16. The computer-readable medium of claim 15, wherein the plurality of instructions, when executed on the computing device, causes the computing device to:
execute the query statement against an in-memory database; and
display columns of information obtained from execution of the query statement.

17. The computer-readable medium of claim 16, wherein the columns of information displayed are selected as a function of the type of report selected.

18. The computer-readable medium of claim 16, wherein the columns of information displayed are selected as a function of the dimensions selected.

19. The computer-readable medium of claim 16, wherein the columns of information displayed are selected as a function of the type of report selected and the dimensions selected.

20. The computer-readable medium of claim 15, wherein the dynamically generated query statement comprises multiple iterative join clauses as a function of the selected dimensions.
